(19) United States
(12) Patent Application Publication
(10) Pub. No.: US 2008/0285640 A1
(43) Pub. Date: Nov. 20, 2008

(54) RF Transmitter With Nonlinear Predistortion and Method Therefor

(75) Inventors: Ronald Duane McCallister, Scottsdale, AZ (US); Eric M. Brombaugh, Mesa, AZ (US)

Correspondence Address: MESCHKOW & GRESHAM, P.L.C., 5727 NORTH SEVENTH STREET, SUITE 409, PHOENIX, AZ, 85014, US

(73) Assignee: CRESTCOM, INC., Scottsdale, AZ (US)

(21) Appl. No.: 11/748,796

(22) Filed: May 15, 2007

(51) Int. Cl. H04L 25/49

(52) U.S. Cl. 375/233; 375/296; 455/114.3

(57) ABSTRACT

An RF transmitter (10) includes a nonlinear predistorter (24). The nonlinear predistorter (24) is implemented using adaptive equalizers (30′, 30″). A feedback signal (20) is developed by downconverting an RF communication signal (16). The feedback signal (20) is used in driving tap coefficients (34) for the adaptive equalizers (30′, 30″). The adaptive equalizers (30′, 30″) filter higher-ordered basis function signals (47′, 47″) generated from an excursion signal 13. The excursion signal 13 exhibits the same phase as a baseline communication signal (12) but has a magnitude that is reduced by a nonlinear threshold (100) when the baseline communication signal (12) exceeds the nonlinear threshold (100) and has a magnitude of zero at other times. The tap coefficients (34) may be formed from proto-coefficients (168) in response to the magnitude of the corresponding portion of the signal being filtered in the adaptive equalizers (30′, 30″).

### RELATED INVENTION

This patent is related to “Transmitter Predistortion Circuit and Method Therefor,” by the inventors of this patent, Ser. No. 11/012,427, filed 14 Dec. 2004, which is a continuation-in-part of “Predistortion Circuit and Method for Compensating A/D and Other Distortion in a Digital RF Communications Transmitter,” by an inventor of this patent, Ser. No. 10/840,735, filed 6 May 2004, which is a continuation-in-part of “A Distortion-Managed Digital RF Communications Transmitter and Method Therefor” by an inventor of this patent, filed 27 Jan. 2004, Ser. No. 10/766,801, each of which is incorporated herein by reference.

This patent is also related to “Equalized Signal Path with Predictive Subtraction Signal and Method Therefor” (Ser. No. 10/971,628, filed 22 Oct. 2004), “Predistortion Circuit and Method for Compensating Linear Distortion in a Digital RF Communications Transmitter” (Ser. No. 10/766,768, filed 27 Jan. 2004), and to “Predistortion Circuit and Method for Compensating Nonlinear Distortion in a Digital RF Communications Transmitter” (Ser. No. 10/766,779, filed 27 Jan. 2004), each invented by an inventor of this patent, and each of which is incorporated herein by reference.

### TECHNICAL FIELD OF THE INVENTION

The present invention relates generally to the field of radio-frequency (RF) communications. More specifically, the present invention relates to the use of predistortion in an RF transmitter to reduce inaccuracies introduced by analog components.

### BACKGROUND OF THE INVENTION

RF transmitters that attempt to provide linear amplification may suffer from a variety of signal distortions. In such applications, real-world RF amplifiers fail to provide perfectly linear amplification, causing spectral regrowth to occur. Since modern regulations place strict limitations on the amount of spectral regrowth that may be tolerated, any signal distortion resulting from nonlinear amplification poses a serious problem for RF transmitter designs. In addition, any linear distortion in the transmitted RF communication signal is undesirable because linear distortion must be overcome in a receiver, often by necessitating transmission at greater power levels than would otherwise be required. Linear distortions may also complicate the spectral regrowth problem.

A variety of well known RF power amplifier and other analog component design techniques may be employed to ensure that nonlinear amplification and other forms of distortion are held to a minimum. But as such techniques get more exotic, the analog component costs increase, and often increase dramatically. Accordingly, predistortion may be a desirable alternative to the use of exotic and expensive analog components, such as highly linearized RF power amplifiers.

Digital predistortion has been applied to digital communication signals prior to signal processing in analog components to permit the use of less expensive power amplifiers and also to improve the performance of more expensive power amplifiers. Digital predistortion refers to digital processing applied to a communication signal while it is still in its digital form, prior to analog conversion. The digital processing attempts to distort the digital communications signal in precisely the right way so that after inaccuracies are applied by linear amplification and other analog processing, the resulting transmitted RF communications signal exhibits negligible residual distortion. To the extent that amplifier nonlinearity is corrected through digital predistortion, lower-power, less-expensive amplifiers may be used, the amplifiers may be operated at their more-efficient, lower-backoff operating ranges, and spectral regrowth is reduced. And, since the digital predistortion is performed through digital processing, it should be able to implement whatever distortion functions it is instructed to implement in an extremely precise manner and at reasonable cost.

The more effective predistortion techniques obtain knowledge of the way in which analog components distort the communications signal in order to craft the proper predistortion-transfer functions that will compensate for distortion introduced by the analog components. A predistortion technique disclosed in the above-listed Related Inventions section hereof uses a collection of adaptive equalizers to determine, implement, and continuously or repeatedly revise such predistortion-transfer functions. One adaptive equalizer filters a baseband communication signal, while other adaptive equalizers filter “basis functions” that are functionally related to the baseband communication signal raised to various powers. Each of the predistortion adaptive equalizers has tap coefficients that define how to predistort the baseband communication signal or basis functions. The tap coefficients are adjusted in response to a feedback signal which provides knowledge about the way in which the analog components are distorting the communication signal at each instant. As a result, feedback loops are formed and tap coefficients are continuously or repeatedly adjusted so that spectral regrowth and linear distortion are minimized.

In a typical RF transmitter, the production of nonlinear energy, leading to spectral regrowth unless cancelled or otherwise restricted, varies as a function of signal power. At lower signal power levels very little nonlinear energy is produced. Thus, many prior art RF transmitters restrict their operation to only the lower signal power levels. But this is an undesirable approach because it requires the use of overly expensive power amplifiers for a given power level requirement, and it forces the power amplifiers to operate inefficiently. At signal levels above this linear range of operation the typical RF transmitter begins to produce more and more nonlinear energy, typically starting out at a low level, but increasing, and typically increasing at an increasing rate, to higher nonlinear energy levels as signal level increases.

Moreover, in many RF communication applications, including cellular basestations, cellular handsets, and other applications, transmission power levels may spend extended periods of time in the lower power ranges of the RF transmitter's capabilities. In other words, even if predistortion or other techniques are used to cancel or otherwise address the unwanted production of nonlinear energy, such techniques should have little effect for extended periods of time when the RF transmitter is operating at a power level that produces little or no nonlinear energy.

These characteristics of typical RF transmitters with respect to the production of nonlinear energy pose challenges for a control system that attempts to track nonlinear energy production in an RF transmitter. For example, a control loop that is responsive to limited duration bursts of nonlinear energy interspersed with extended periods of little nonlinear energy is likely to be somewhat responsive to noise as well. And, a control loop that is insensitive to noise is likely to do a poor job of tracking bursts of nonlinear energy interspersed with extended periods of little nonlinear energy. For either scenario, nonlinear energy generated in response to the operation of the control loop is likely to be less accurately configured for purposes of cancellation than it could be.

A predistortion technique disclosed in the above-listed Related Inventions section hereof uses a cancellation scheme where nonlinear energy, which has a bandwidth commensurate with the spectral regrowth, is added to a baseband communication signal so that after upconversion and amplification this cancellation energy will cancel the spectral regrowth energy produced as a result of nonlinear amplification. The basis for this scheme rests on a series expansion (e.g., Taylor series, Volterra series, etc.) of the nonlinear phenomenon. Thus, an equivalent to the signals produced by the nonlinear amplification phenomenon may be provided by a combination of signals characterized by a collection of higher-ordered derivatives of the nonlinearity at a point of expansion. But, these higher-ordered derivatives change at different levels of amplification, or at different points of expansion. Thus, a series expansion that is equivalent to the nonlinear amplification phenomenon at one magnitude of the communication signal is not equivalent at another magnitude. Consequently, a collection of nonlinear signals is derived that accurately equates to the nonlinearity at an average signal magnitude, but that is less accurate than desired the vast majority of the time when the communication signal does not exhibit its average. This causes the nonlinear cancellation energy to be less accurate than desired, and limits the effectiveness of the predistortion.

### SUMMARY OF THE INVENTION

It is an advantage of at least one embodiment of the present invention that an improved RF transmitter with nonlinear predistortion and a method therefor are provided.

Another advantage of at least one embodiment of the present invention is that the configuration of nonlinear energy intentionally generated for purposes of cancellation in response to the operation of a feedback control loop is improved.

Another advantage of at least one embodiment of the present invention is that nonlinear energy intentionally generated for purposes of cancellation is blocked at times when a power amplifier is unlikely to be producing nonlinear energy.

Another advantage of at least one embodiment of the present invention is that nonlinear energy intentionally generated for purposes of cancellation is generated from an excursion signal that resembles a baseband communication signal in some aspects but has a reduced dynamic range.

Another advantage of at least one embodiment of the present invention is that an adaptive equalizer that establishes, at least in part, the configuration of nonlinear energy intentionally generated for purposes of cancellation is restricted in adapting its tap coefficients at times when a power amplifier is unlikely to be producing nonlinear energy.

Another advantage of at least one embodiment of the present invention is that an adaptive equalizer that establishes, at least in part, the configuration of nonlinear energy intentionally generated for purposes of cancellation adjusts that configuration in response to the magnitude of a baseband communication signal.

Another advantage of at least one embodiment of the present invention is that an adaptive equalizer that establishes, at least in part, the configuration of nonlinear energy intentionally generated for purposes of cancellation forms tap coefficients from proto-coefficients in response to signal magnitude at a time corresponding to the filtering taking place in the adaptive equalizer, then later adapts the proto-coefficients through an LMS process.

These and other advantages are realized in one form by an RF transmitter with nonlinear predistortion. The transmitter includes a nonlinear predistorter. The nonlinear predistorter includes an excursion signal generator configured to form a reduced-range baseline communication signal in response to a full-range baseline communication signal. The reduced-range baseline communication signal exhibits a smaller dynamic range than the full-range baseline communication signal. The nonlinear predistorter also includes a basis function generator responsive to the reduced-range baseline communication signal and configured to generate a basis function signal. And, the nonlinear predistorter includes an adaptive equalizer responsive to the basis function signal and configured to form a nonlinear distortion cancellation signal. A combiner is responsive to the nonlinear distortion cancellation signal and the baseline communication signal and is configured to produce a predistorted communication signal. A power amplifier is located downstream of the combiner and is configured to generate an RF communication signal.

The above and other advantages are realized in another form by a method of operating an RF transmitter. The method calls for generating a basis function signal in response to a baseline communication signal. The basis function signal is filtered to form a nonlinear distortion cancellation signal. The nonlinear distortion cancellation signal is configured to exhibit approximately zero magnitude in correspondence to the baseline communication signal exhibiting a magnitude less than a nonlinear threshold. The nonlinear threshold represents a magnitude of the baseline communication signal at which the RF transmitter begins to produce a substantial amount of nonlinear distortion. The nonlinear distortion cancellation signal is combined with the baseline communication signal to produce a predistorted communication signal. And, the predistorted communication signal is processed through analog transmitter components.

The above and other advantages are realized in another form by a method of operating an RF transmitter. The method calls for generating a basis function signal responsive to a baseline communication signal. The basis function signal is filtered in an adaptive equalizer having a tap coefficient and forming a nonlinear distortion cancellation signal. The tap coefficient is formed from at least two proto-coefficients in response to a portion of the baseline communication signal which corresponds to the filtering activity. The nonlinear distortion cancellation signal is combined with the baseline communication signal to produce a predistorted communication signal. The predistorted communication signal is processed through analog transmitter components to generate an RF communication signal. A feedback signal is generated in response to the RF communication signal. At least one of the proto-coefficients is adjusted in response to the feedback signal.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a block diagram of an RF transmitter configured in accordance with one embodiment of the present invention;

FIG. 2 shows a simplified block diagram of an adaptive equalizer that may be used in implementing the RF transmitter of FIG. 1;

FIG. 3 graphically shows a representative plot of input signal magnitude versus output signal magnitude for a typical RF power amplifier;

FIG. 4 shows a block diagram of an excursion signal generator usable in a nonlinear predistorter portion of the RF transmitter of FIG. 1;

FIG. 5 graphically shows the generation of a single sample of an excursion signal in response to an exemplary sample of a baseline communication signal;

FIG. 6 graphically shows modulation of convergence factors applied to the nonlinear predistorter portion of the RF transmitter of FIG. 1;

FIG. 7 shows a block diagram of an exemplary basis function generator usable in a nonlinear predistorter portion of the RF transmitter of FIG. 1;

FIG. 8 graphically shows an example of how the magnitude of the excursion signal may vary over time;

FIG. 9 shows a block diagram of a single cell from one embodiment of the adaptive equalizer of FIG. 2; and

FIG. 10 schematically shows relative timings of events which occur within the RF transmitter while processing information associated with a single sample of the baseline communication signal.

### DETAILED DESCRIPTION OF THE PREFERRED EMBODIMENTS

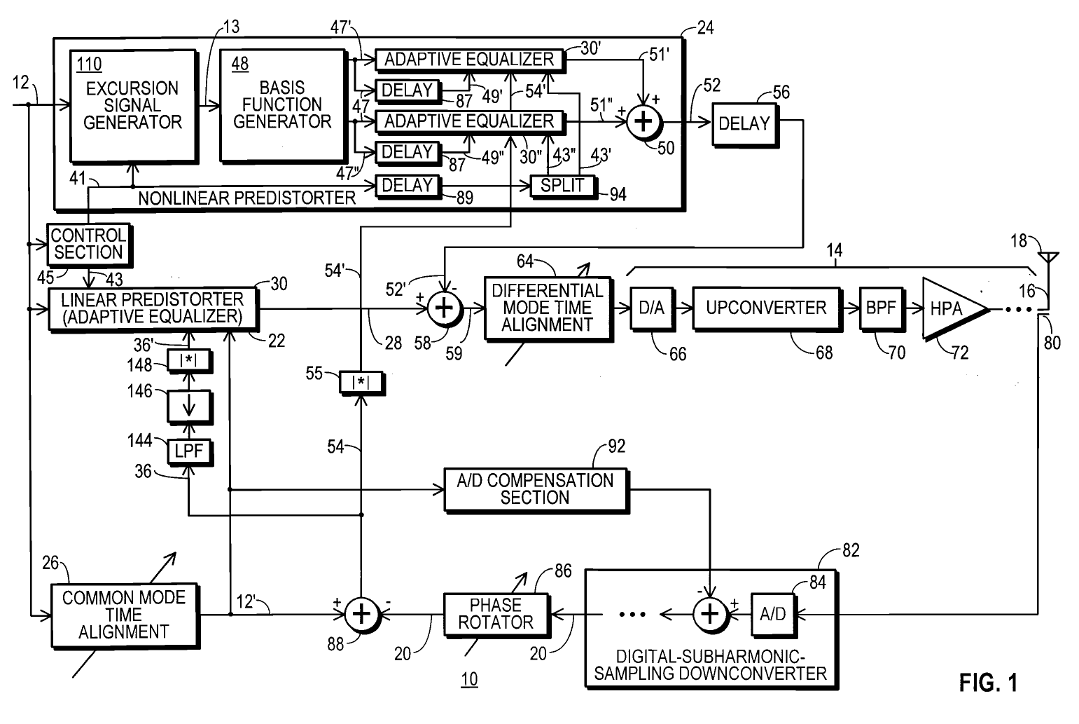

FIG. 1 shows a block diagram of an RF transmitter 10 configured in accordance with one embodiment of the present invention. RF transmitter 10 is adapted to receive a baseline communication signal 12. Baseline communication signal 12 is a complex digital signal having in-phase and quadrature components, preferably frequency-located at baseband.

As received at transmitter 10, baseline communication signal 12 has been digitally modulated to convey any and all data to be communicated by RF transmitter 10, using any of a wide variety of digital modulation techniques known to those skilled in the art. In addition, pulse-shape filtering may have been applied to reduce intersymbol interference in a manner known to those skilled in the art, signal peaks may have been limited to reduce a peak-to-average power ratio (PAPR), and other signal processing tasks may have been performed to produce baseline communication signal 12. Even though upstream tasks may have affected the magnitude characteristics of baseline communication signal 12, for the purposes of RF transmitter 10, baseline communication signal 12 is deemed to be a full-range baseline communication signal. In other words, baseline communication signal 12 exhibits the full dynamic range needed to convey the data to be communicated by RF transmitter 10, and subsequent deviations from this full dynamic range in the communication signal are viewed as deviations from the baseline.

In general, RF transmitter 10 predistorts baseline communication signal 12 to compensate for distortions introduced downstream of the predistortion in analog transmitter components 14. Analog transmitter components 14 convert the predistorted version of the communication signal into an RF communication signal 16, which is subsequently broadcast from an antenna 18. But a portion of the RF communication signal 16 is converted into a feedback signal 20 which controls the nature of the predistortion applied to baseline communication signal 12.

Baseline communication signal 12 drives a linear predistorter 22, a nonlinear predistorter 24, and a common mode time alignment block 26. Linear predistorter 22 filters baseline communication signal 12 so that the output of linear predistorter 22 presents a linear-predistorted form 28 of the baseline communication signal. In a preferred embodiment, an adaptive equalizer 30 is configured to serve as linear predistorter 22.

In an excursion signal generator 110, nonlinear predistorter 24 forms a reduced-range baseline communication signal 13 from full-range baseline communication signal 12. Reduced-range baseline communication signal 13 is also referred to herein as an excursion signal. Reduced-range baseline communication signal 13 exhibits a smaller dynamic range of magnitude than that exhibited by full-range baseline communication signal 12. Excursion signal generator 110 is discussed in more detail below in connection with FIGS. 4-5.

Nonlinear predistorter 24 desirably generates a plurality of higher-order basis function signals 47 at a basis function generator 48 in response to the reduced-range excursion signal form 13 of baseline communication signal 12. Basis function signals 47 are functionally related to baseline communication signal 12 squared, cubed, and so on. Baseline communication signal 12 may be up-sampled using interpolators or the like (not shown) to a sample rate compatible with the higher bandwidth of the basis function signals. In the preferred embodiment, basis function signals 47 are as orthogonal to each other as is reasonably possible, but this is not a requirement. Orthogonality may be achieved, for example, in accordance with a well known Gram-Schmidt orthogonalization technique. Moreover, in the preferred embodiment only a second-order basis function signal 47′ and a third-order basis function signal 47″ are generated in section 48, but this is not a requirement either. Basis function generator 48 is discussed in more detail below in connection with FIG. 7.

Nonlinear predistorter 24 desirably equalizes basis function signals 47 through independent adaptive equalizers 30′ and 30″, then combines the equalized basis function signals 51′ and 51″ at an adder 50 into a nonlinear distortion cancellation signal 52.

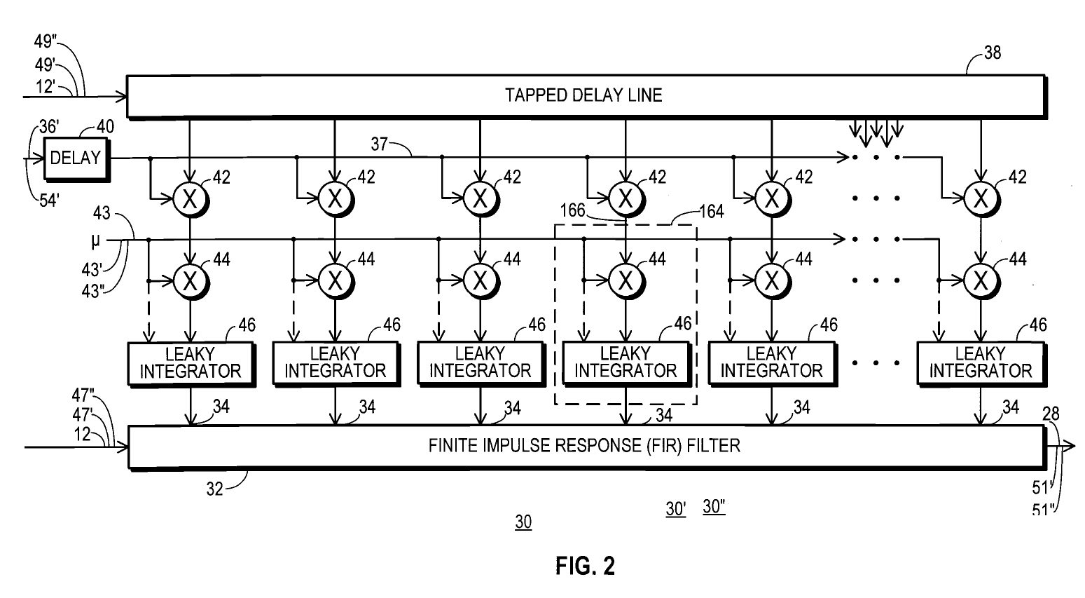

FIG. 2 shows a simplified block diagram of an adaptive equalizer that is suitable for use as any of adaptive equalizers 30, 30′, or 30″. For this discussion of FIG. 2, all adaptive equalizers, regardless of application, will be referred to as adaptive equalizer 30. Adaptive equalizer 30 includes a finite impulse response (FIR) filter 32. For the linear predistorter 22 application, filter 32 receives baseline communication signal 12 at a data input of filter 32 and filters baseline communication signal 12 so that linear-predistorted baseline communication signal 28 is produced at a data output of filter 32. For nonlinear predistorter 24, the input data stream is provided by basis function signals 47′ and 47″.

For the purposes of simplification, FIG. 2 depicts only a “real-signal” implementation of filter 32 and adaptive equalizer 30. But those skilled in the art will appreciate that adaptive equalizer 30 preferably processes complex signals and that a “complex-signal” implementation, which is well understood by those skilled in the art, is preferred. The nature of the filtering applied by filter 32 is defined by tap coefficients 34 provided at control inputs to filter 32. Adaptive equalizer 30 may be implemented to accommodate any number of tap coefficients 34. And, a generous number of taps is contemplated in connection with adaptive equalizer 30 when configured for use as linear predistorter 22. For purposes of comparison, adaptive equalizers 30 within nonlinear predistorter 24 may use far fewer taps but operate at a higher clock rate.

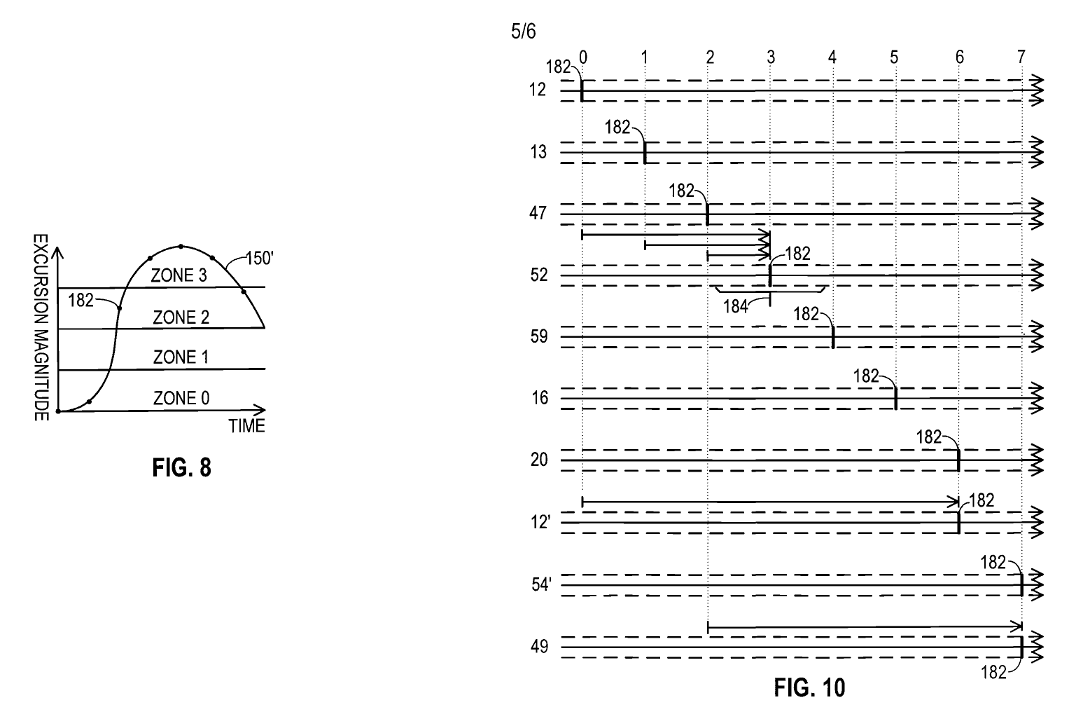

In adaptive equalizer 30, tap coefficients 34 are adaptable. In other words, tap coefficients 34 are either continuously or repeatedly adjusted so that the definition that specifies how to predistort the input data stream (e.g., baseline communication signal 12 or basis function signals 47) tracks changes in RF transmitter 10 and baseline communication signal 12. In a preferred embodiment, tap coefficients 34 adapt in response to a Least Mean Square (LMS) algorithm, and also to a leaky-tap update algorithm. These algorithms adapt tap coefficients 34 in response to the input data stream (e.g., baseline communication signal 12, and more particularly to a form 12′ of baseline communication signal 12 that has been delayed, or basis function signals 47, and more particularly to forms 49′ or 49″ of respective basis function signals 47′ and 47″ that have been delayed). In addition, tap coefficients 34 adapt in response to an error signal (e.g., error signals 36′ or 54′) which is formed from feedback signal 20 (FIG. 1), and more particularly from a difference between feedback signal 20 and baseline signal 12, as discussed in more detail below. In one embodiment discussed below in connection with FIGS. 8-10, tap coefficients 34 for the adaptive equalizers 30 used in nonlinear predistorter 24 are formed on a sample-by-sample basis from at least two proto-coefficients in response to signal magnitude, and it is the proto-coefficients that adapt in response to an LMS algorithm.

The delayed input data stream (e.g., baseline communication signal 12′ or basis function signals 49′ or 49″) drives a tapped delay line 38 having roughly the same number of taps as FIR filter 32. The error signal 36 or 54, preferably in a conjugate form 36′ or 54′, is delayed in a delay element 40 that preferably postpones the error signal 36′ or 54′ for about one-half of the total delay of tapped delay line 38. The taps from tapped delay line 38 drive first inputs of multipliers 42, and a delayed error signal 37 output from delay element 40 drives second inputs of all multipliers 42. Prior to application at adaptive equalizer 30, error signals 36′ or 54′ have been aligned so that they have substantially the same timing as the respective delayed input data stream (e.g., baseline communication signal 12′ or delayed basis function signals 49′ or 49″), so delayed error signal 37 is aligned in time approximately at the center of filter 32 and tapped delay line 38. At the various taps of adaptive equalizer 30, multipliers 42 determine correlation between the error signal 36′ or 54′ and the input data stream on a cycle by cycle basis. Thus, tap coefficients 34 adapt in response to a product of the input data stream and the error signal.

Outputs from multipliers 42 are provided to first inputs of corresponding multipliers 44, and a convergence factor 43 “p” drives second inputs of all multipliers 44. More particularly, a convergence factor 43′ is generated for the linear predistorter 22 application and convergence factors 43′ and 43″ are generated for the nonlinear predistorter 24 application. For each application, convergence factor 43 is set to achieve as rapid a loop convergence as practical without experiencing undue jitter. In one embodiment, convergence factor 43 is initially set at a faster convergence/higher jitter setting when RF transmitter 10 is first initialized, then adjusted toward a slower convergence/lower jitter setting as RF transmitter 10 becomes operational.

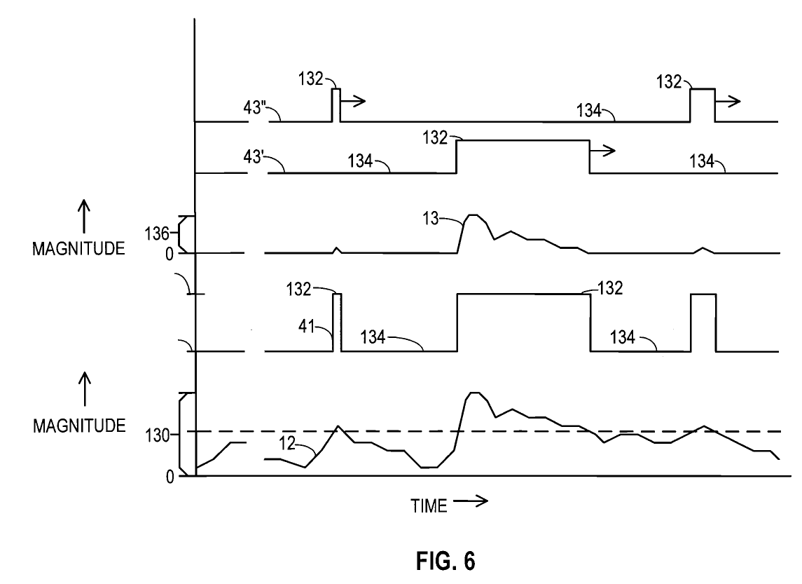

In one embodiment, a control section 45 (FIG. 1) receives an input from baseline communication signal 12 and modulates convergence factors 43 in response to the amplitude of baseline communication signal 12. This embodiment is discussed below in more detail in connection with FIG. 6.

Corresponding outputs from multipliers 44 are provided to leaky integrators 46. Those skilled in the art will appreciate that integrators 46 are made “leaky” by, for example, subtracting a small but easily obtained offset, such as one sixty-fourth or one two-hundred-fifty-sixth, of the integrator output from the integrator input during each clock cycle. The use of leaky integrators 46 causes tap coefficients 34 to adapt in accordance with a leaky-tap LMS algorithm. The leaky-tap LMS algorithm causes the predistortion imparted to the input data stream to be very slightly less perfect than would be the result if no leaky-tap algorithm were used. But the leaky-tap algorithm reduces the already low likelihood of predistortion error and loop instability.

Accordingly, for the linear predistorter 22 application, positive or negative correlation between baseline communication signal 12′ and conjugate error signal 36′ causes tap coefficients 34 to drift to a value that, after operation of a feedback loop discussed herein, leads to a reduction in such correlation. In one application in nonlinear predistorter 24, positive or negative correlation between second-order basis function signal 49′ and conjugate error signal 54′ causes tap coefficients 34 to drift to a value that, after operation of a feedback loop, leads to a reduction in such correlation. In another application in nonlinear predistorter 24, positive or negative correlation between third-order basis function signal 49″ and conjugate error signal 54′ causes tap coefficients 34 to drift to a value that, after operation of a feedback loop, leads to a reduction in such correlation.

Referring back to FIG. 1, nonlinear distortion cancellation signal 52 is delayed in a delay element 56, then a delayed version 52′ of nonlinear distortion cancellation signal 52 is combined with the linear-predistorted form 28 of the baseline communication signal in a combination circuit 58 to form a predistorted communication signal 59. Delay element 56 delays nonlinear distortion cancellation signal 52 so that the amount of delay experienced by baseline communication signal 12 through nonlinear predistorter 24 and delay element 56 equals the delay experienced through linear predistorter 22. Although not shown, linear-predistorted baseline communication signal 28 is desirably up-sampled to match the sample rate of nonlinear distortion cancellation signal 52 prior to combination in combination circuit 58.

In one of many alternate embodiments to the above-described architecture, unlike the architecture depicted in FIG. 1 basis function signals may be combined with baseline communication signal 12, then the resulting combination filtered in linear predistorter 22. But this alternate embodiment requires operating linear predistorter 22 at a higher sample rate.

Delayed nonlinear distortion cancellation signal 52′ combines an “inverse” nonlinear distortion with linearly predistorted baseline communication signal 28. The magnitude and spectral character of inverse nonlinear distortion applied at combination circuit 58 is roughly configured to be the inverse of the nonlinear distortions RF communication signal 16 will encounter downstream so that the downstream distortions will cancel the inverse distortion applied at combination circuit 58, resulting in less distortion in the broadcast version of RF communication signal 16 than would result without the operation at combination circuit 58. More precisely, the feedback loops used to define the predistortion result in distorted basis function signals 47 that, after regenerating into an even more spectrally rich signal mixture by being processed through nonlinear analog components 14, lead to cancellation in RF communication signal 16.

After the combination operation of combining circuit 58, the combined predistorted communication signal 59 passes through a variable, differential-mode, time alignment section 64. Differential time alignment refers to relative delay inserted into one of the in-phase and quadrature-phase legs of the complex communication signal in order to compensate for the likelihood of different delays in the in-phase and quadrature signal paths between digital-to-analog conversions and direct upconversion, which occur downstream. Section 64 may be implemented using a fixed delay of less than one clock interval in one of the legs of the complex communication signal and an interpolator in the other.

After differential timing adjustment in section 64, predistorted communication signal 59 passes to analog transmitter components 14. Analog transmitter components 14 include a wide variety of analog components well known to those of skill in the art of RF transmitters. Typical analog transmitter components 14 may include separate digital-to-analog (D/A) converters 66 for each leg of the complex communication signal. D/A's 66 convert the complex communication signal from digital to analog signals. Subsequent processing of the communication signal will now be analog processing and subject to the inaccuracies characteristic of analog processing. For example, the two different D/A's 66 may not exhibit precisely the same gain and may introduce slightly different amounts of delay. Such differences in gain and delay can lead to linear distortion in RF communication signal 16. Moreover, so long as the different legs of the complex signal are processed separately in different analog components, the components are likely to apply slightly different frequency responses so that linear distortion is worsened by the introduction of frequency-dependent gain and phase imbalances. And, the frequency-dependent gain and phase imbalances worsen as the bandwidth of the communication signal widens.

The two complex legs of the analog communication signal pass from D/A's 66 to two low-pass filters (not shown), which can be the source of additional linear distortion by applying slightly different gains and phase shifts in addition to slightly different frequency-dependent characteristics. Then, the two complex legs pass to an upconverter 68. Upconverter 68 mixes the two complex legs with a local-oscillator signal (not shown) in a manner known to those skilled in the art. Additional linear distortion in the form of gain and phase imbalance may be introduced, and local-oscillator leakage may produce an unwanted DC offset. In addition, upconverter 68 combines the two distinct legs of the complex signal and passes the combined signal to a band-pass filter (BPF) 70.

BPF 70 is configured to block unwanted sidebands in the upconverted communication signal, but will also introduce additional distortion. The communication signal then passes from BPF 70 to a high-power RF amplifier (HPA) 72. HPA 72 is likely to be the source of a variety of linear and nonlinear distortions introduced into RF communication signal 16. In accordance with a Wiener-Hammerstein RF-amplifier model, HPA 72 acts like an input band-pass filter, followed by a memoryless nonlinearity, which is followed by an output band-pass filter. The memoryless nonlinearity generates an output signal that may be a higher-order complex polynomial function of its input. Each of input and output bandpass filters may introduce linear distortion, but probably little significant nonlinear distortion. On the other hand, the memoryless nonlinearity is a significant source of nonlinear distortion.

RF communication signal 16 then passes from HPA 72 through other analog components, which may include additional filtering, a duplexer, transmission lines, and the like, where additional distortions may be introduced. Eventually, RF communication signal 16 is broadcast from RF transmitter 10 at antenna 18.

RF transmitter 10 uses feedback obtained from RF communication signal 16 to control the linear and nonlinear predistortions applied to the communication signal as discussed above so as to minimize the distortions. In particular, a portion of RF communication signal 16 is obtained from a directional coupler 80 located upstream of antenna 18 and routed to an input of a digital-subharmonic-sampling downconverter 82. Downconverter 82 serves as a feedback signal generator and generates feedback signal 20 in response to RF communication signal 16.

Desirably, RF communication signal 16 is routed as directly as possible to downconverter 82 without being processed through analog components that will introduce a significant amount of linear or nonlinear distortion. Such distortions could be mistakenly interpreted by linear and nonlinear predistorters 22 and 24 as being introduced while propagating toward antenna 18 and compensated. Thus, reverse path distortions might possibly have the effect of causing predistorters 22 and 24 to insert distortion that will have no distortion-compensating effect on the actual RF communication signal 16 broadcast from antenna 18 and will actually contribute to an increase in distortion. In a manner understood by those skilled in the art, digital-subharmonic-sampling downconverter 82 simultaneously performs downconversion from RF to baseband with conversion from analog to digital using a digital sampling process that eliminates the types of analog processing that might introduce distortions.

Downconverter 82 includes an analog-to-digital converter (A/D) 84 to perform both the downconversion and analog-to-digital conversion. Desirably, the same local-oscillator signal used by upconverter 68 passes to a synthesizer (not shown) configured to multiply the local-oscillator frequency by four and divide the resulting product by an odd number, characterized as 2N±1, where N is a positive integer chosen to satisfy the Nyquist criteria for the bandwidth being downconverted, and is usually greater than or equal to ten. The subharmonic sampling process tends to sum thermal noise from several harmonics of the baseband into the resulting baseband signal, thereby increasing noise over other types of downconversion. While these factors pose serious problems in many applications, they are no great burden here because noise is generally uncorrelated with baseline communication signal 12. In addition, downconverter 82 desirably includes demultiplexing and Hilbert transformation functions (not shown) to digitally convert the downconverted signal into a complex baseband signal, which serves as feedback signal 20. Since such functions are performed digitally, no significant distortion is introduced.

Feedback signal 20 passes from downconverter 82 to a variable phase rotator 86. Variable phase rotator 86 is adjusted to alter the phase of feedback signal 20 primarily to compensate for the phase rotation introduced by BPF 70. As discussed above, baseline communication signal 12 passes to common mode time alignment section 26. Common mode time alignment refers to delay that is inserted equally into both of the in-phase and quadrature-phase legs of the complex communication signal. Section 26 delays baseline communication signal 12 at the output of section 26 to form a delayed version of baseline communication signal 12, depicted in FIG. 1 with the reference number 12′. Baseline communication signal 12′ is in temporal alignment with the linear component of feedback signal 20 as presented at the output of phase rotator 86. At these locations baseline communication signal 12 is combined in a combiner 88 with feedback signal 20 to form error signal 54. Desirably, differential mode time alignment section 64, phase rotator 86, and common mode time alignment section 26 are all adjusted so that the correlation between baseline communication signal 12′ and the linear component of feedback signal 20 output from phase rotator 86 is maximized.

In one embodiment, baseline communication signal 12′ also drives an A/D compensation section 92. An output of A/D compensation section 92 is fed back to downconverter 82 to improve the linearity of A/D 84, if necessary.

A conjugator 55 generates a conjugated form 54′ of error signal 54. In the preferred embodiment, conjugated error signal 54′ is routed to adaptive equalizers 30′ and 30″ for use in adapting their tap coefficients 34 (FIG. 2). When the delay of section 26 has been determined, a corresponding delay is programmed into delay elements 87 and 89 within nonlinear predistorter 24. Basis function signals 47 are delayed in delay elements 87 by an amount that places them in temporal alignment with conjugated error signal 54′. Likewise, a primary convergence factor signal 41 is delayed in delay element 89 so that convergence factors 43′ and 43″ (FIG. 2) formed from signal 41 are also in temporal alignment with conjugated error signal 54′. Delayed forms 49′ and 49″ of basis function signals 47′ and 47″, are respectively routed to adaptive equalizers 30′ and 30″ for use in adapting their tap coefficients 34 or proto-coefficients as discussed below in FIG. 10. A delayed form of primary convergence factor signal 41 is routed to a splitting section 94 which forms convergence signals 43′ and 43″ from convergence factor signal 41. The operation of splitting section 94 is discussed below in connection with FIG. 6.

In one embodiment, feedback signal 20 output from phase rotator 86 and baseline communication signal 12′ also drive an intermodulation-product canceller (not shown) which generates an error signal 36. But in the embodiment depicted in FIG. 1, error signal 36 is substantially equivalent to error signal 54. Error signal 36 passes through a low-pass filter (LPF) 144, a decimator 146, and a conjugator 148. LPF 144 and decimator 146 together reduce the sampling rate of error signal 36 to a slower rate consistent with the operation of linear predistorter 22. Conjugator 148 produces the conjugated form 36′ of error signal 36 that is used, along with baseline communication signal 12′ in adapting tap coefficients 34 in the adaptive equalizer 30 that serves as linear predistorter 22.

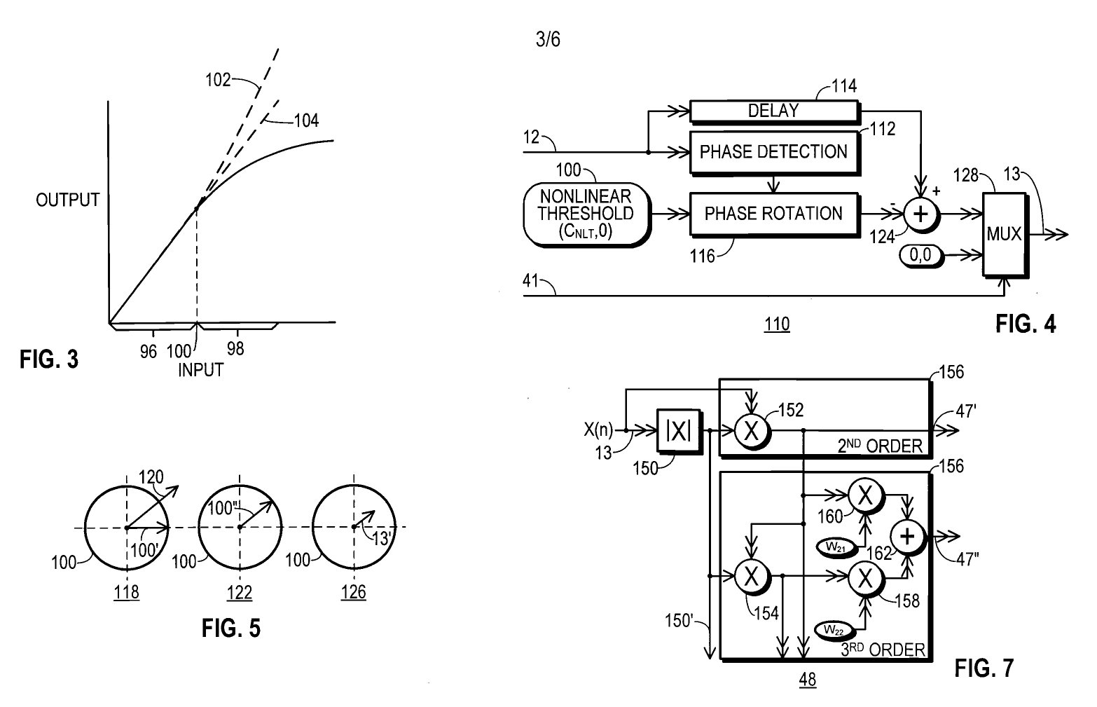

FIG. 3 graphically shows a representative plot of input signal magnitude versus output signal magnitude for a typical RF power amplifier, such as may be used for HPA 72. FIG. 3 depicts two regions of operation. In a linear region 96, the output signal is a linear function of the input signal magnitude. In other words, regardless of the slope of the relationship or of any offset between output and input, the output signal is, for the most part, mathematically related to the input signal raised to only the first power, and the slope between the input and output signals is substantially constant. But in a nonlinear region 98, the output signal is a nonlinear function of the input signal. The slope is constantly diminishing as input signal magnitude increases. A nonlinear threshold 100 is established to denote the boundary between regions 96 and 98.

In the preferred embodiment, the technique to be used in establishing nonlinear threshold 100 is not critical. In general, nonlinear threshold 100 represents the magnitude of baseline communication signal 12 at which HPA 72 begins to produce a substantial amount of nonlinear distortion. But if nonlinear threshold 100 is not precisely placed, only small amounts of performance degradation should result. In one embodiment, nonlinear threshold 100 is established at manufacture as a constant. In another embodiment, nonlinear threshold 100 is detected by a calibration process that sets nonlinear threshold 100 in response to the amount of nonlinear energy measured in feedback signal 20. In yet another embodiment, nonlinear threshold 100 is established in a feedback loop having a slow loop bandwidth which continuously or repeatedly, but very slowly, varies nonlinear threshold 100 a small amount about an average value, monitors the resulting error vector magnitude (EVM) observed in feedback signal 20, and moves the average nonlinear threshold value 100 in a direction that leads to improved EVM.

Desirably, the nonlinear distortion produced by HPA 72 is greatly attenuated by the configuration of predistorting linear and nonlinear energy at the input of HPA 72. Accordingly, starting at nonlinear threshold 100 and moving toward greater input signal magnitudes, input signal magnitude is distorted as depicted in nonlinear dotted line 102 so that the realized output from HPA 72 after cancellation resembles linear dotted line 104.

FIG. 4 shows a block diagram of excursion signal generator 110. Baseline communication signal 12 is supplied to a phase detection section 112 and to a delay section 114. In FIG. 4, a double arrow notation on lines interconnecting boxes is used to signify a complex signal. Nonlinear threshold 100 (CNLT) is a scalar value that is converted into a complex signal having a phase of zero and then supplied to a phase rotation section 116. For the purposes of FIG. 4 and for explaining the short-term operation of excursion signal generator 110, nonlinear threshold 100 may be viewed as being constant.

FIG. 5 graphically shows the generation of a single sample of excursion signal 13 in response to an exemplary sample of baseline communication signal 12. With respect to a stage 118 depicted in FIG. 5, a vector 120 represents the exemplary sample from the data stream that presents baseline communication signal 12. For this particular example, vector 120 exhibits a magnitude greater than nonlinear threshold 100. Of course, different samples from baseline communication signal 12 can depict any magnitude within the dynamic range of baseline communication signal 12 or any phase and are not restricted to the example of FIG. 5. Stage 118 also depicts nonlinear threshold 100 converted into a vector 100′ having a phase of zero.

Referring to FIGS. 4 and 5, phase detection section 112 provides an output that couples to a control input of phase rotation section 116. Phase detection section 112 determines the phase of vector 120 and supplies that phase determination to phase rotation section 116 so that phase rotation section 116 can then rotate vector 100′ the same amount in an opposite direction. Both phase detection and phase rotation sections 112 and 116 may be implemented using Cordic processors, which are well known to those skilled in the art. A stage 122 in FIG. 5 depicts the result of the phase rotation of section 116. A vector 100″ which exhibits the magnitude of nonlinear threshold 100 has now been rotated to the phase of baseline communication signal sample vector 120.

Delay section 114 delays baseline communication signal 12 so that it is temporally aligned with the output from phase rotation section 116. Outputs from delay section 114 and from phase rotation section 116 respectively couple to positive and negative inputs of a summation circuit 124. Accordingly, summation circuit 124 subtracts rotated nonlinear threshold vector 100″ from baseline communication sample vector 120. A third stage 126 in FIG. 5 depicts the result of this subtraction operation. An excursion sample 13′ from excursion signal 13 is produced having the same phase as the corresponding baseline communication signal 12 but having a reduced magnitude. In particular, the magnitude of excursion signal sample 13′ is reduced by the magnitude of nonlinear threshold 100. In other words, the magnitude of excursion signal sample 13′ is equal to the amount by which the magnitude of baseline communication signal 12 exceeded nonlinear threshold 100 for the subject sample.

An output from summation circuit 124 couples to a first data input of a multiplexing section (MUX) 128, and a constant, complex value of zero is applied to a second data input of multiplexing section 128. A selection input of multiplexing section 128 is driven by primary convergence factor signal 41 from control section 45.

FIG. 6 graphically shows the operation of excursion signal generator 110 and the modulation of convergence factors applied to nonlinear predistorter 24. Control section 45 is desirably configured to monitor the instantaneous magnitude of baseline communication signal 12 in one embodiment. But the monitoring of baseline communication 12 itself is not critical. Control section 45 may alternatively monitor various signals which are derived from baseline communication signal 12 because such signals are highly correlated with one another with respect to the parameter of signal magnitude.

FIG. 6 also shows an exemplary representation of the magnitude of communication 12. Baseline communication signal 12 is shown exhibiting magnitudes that vary within a dynamic range 130. On a sample by sample basis control section 45 desirably compares the magnitude of communication 12 to nonlinear threshold 100, and when the magnitude exceeds threshold 100 causes primary convergence factor signal 41 to exhibit a level 132 that signifies operation in nonlinear region 98 (FIG. 3). As soon as the magnitude of communication signal 12 drops below threshold 100 primary convergence factor signal 41 is returned to a level 134 that signifies operation in linear region 96 (FIG. 3).

In one embodiment, an inversion of signal 41 serves as convergence factor signal 43 that is supplied to adaptive equalizer 30 in linear predistorter 22 for use in adapting tap coefficients 34. Thus, tap coefficients 34 of adaptive equalizer 30 in linear predistorter 22 are frozen and cease to be adjusted when operating in nonlinear region 98. In another embodiment, convergence factor signal 43 may be generated by a similar comparison operation that uses a different threshold from nonlinear threshold 100. Regardless, in this embodiment the adaptation of tap coefficients 34 for the adaptive equalizer 30 that serves as linear predistorter 22 diminishes or ceases altogether when operating in nonlinear region 98.

Referring back to FIG. 4, primary convergence factor signal 41 causes multiplexer 128 to generate excursion signal samples 13′ whenever baseline communication signal 12 indicates operation in nonlinear region 98 and values of zero when operating in linear region 96. The result is excursion signal 13, depicted in exemplary form in FIG. 6. Excursion signal 13 exhibits substantially the same phase as baseline communication signal 12, but at a reduced magnitude. The magnitude of excursion signal 13 is confined within a dynamic range 136 that is smaller than the dynamic range 130 of baseline communication signal 12. At least a portion of excursion signal 13 exhibits a magnitude reduced from the magnitude of baseline communication signal 12 by an offset substantially equal to nonlinear threshold 100. That portion is the non-zero portion of excursion signal 13. The zero portion of excursion signal 13, which is produced in correspondence to baseline communication signal 12 exhibiting magnitudes less than nonlinear threshold 100, also causes nonlinear distortion cancellation signal 52 to exhibit a magnitude of approximately zero after propagation through basis function generator 48 and adaptive equalizers 30′ and 30″.

FIG. 7 shows one embodiment of a block diagram of an exemplary basis function generator 48. This embodiment is desirable because it achieves substantially orthogonal basis function signals using a relatively simple hardware implementation. But while basis function generator 48 provides suitable results for the purposes of nonlinear predistorter 24, those skilled in the art will be able to devise acceptable alternate embodiments.

The signal referenced as X(n) that FIG. 7 depicts at the input to basis function generator 48 represents excursion signal 13. Excursion signal 13 is also the reduced-range baseline communication signal formed from full-range baseline communication signal 12. Excursion signal 13 is a complex signal, as denoted by the double-arrow notation. Excursion signal 13 is received at a magnitude circuit 150 and at a multiplier 152. Magnitude circuit 150 generates a scalar data stream 150′ that describes the magnitude of excursion signal 13 and is routed to multiplier 152, as well as to a multiplier 154. FIG. 7 indicates that basis function generator 48 is segmented into cells 156, with each cell 156 generating one basis function signal. Multipliers 152 and 154 are respectively associated with different cells 156. Generally, each basis function signal is responsive to X(n)·↑X(n)|^{K}, where X(n) represents excursion signal 13, and K is an integer number greater than or equal to one. The outputs of multipliers 152 and 154 are X(n)·|X(n)|^{K} data streams.

But in order to achieve substantial orthogonality, each basis function equals the sum of an appropriately weighted X(n)·|X(n)|^{K} stream and all appropriately weighted lower-ordered X(n)·|X(n)|^{K} streams. Accordingly, the output from multiplier 152 directly serves as the 2^{nd} order basis function signal, and provides second-order basis function signal 47′. The output from multiplier 154 is multiplied by a coefficient W₂₂ at a multiplier 158, and the output from multiplier 152 is multiplied by a coefficient W₂₁ at a multiplier 160. The outputs of multipliers 158 and 160 are added together in an adder 162, and the output of adder 162 serves as third-order basis function signal 47″. In the preferred embodiment, the coefficients are determined during the design process by following a Gram-Schmidt orthogonalization technique, or any other orthogonalization technique known to those skilled in the art. As such, the coefficients remain static during the operation of RF transmitter 10. But nothing prevents the coefficients from changing from time-to-time while RF transmitter 10 is operating if conditions warrant.

Those skilled in the art will appreciate that basis-function-generator 48 may be expanded by adding additional cells 156 to provide any desired number of basis function signals. Moreover, those skilled in the art will appreciate that pipelining stages may be added as needed to accommodate the timing characteristics of the components involved and to insure that each basis function signal has substantially equivalent timing. The greater the number of basis function signals, the better nonlinear distortion may be compensated for. But the inclusion of a large number of basis function signals will necessitate processing a very wideband signal at a high data rate.

Accordingly, basis function generator 48 generates one or more basis function signals 47 responsive to baseline communication signal 12. More particularly, basis function generator 48 is responsive to reduced-range baseline communication signal 13. Second-order basis function signal 47′ is responsive to X(n)·|X(n)|^{K}, where K=1 and X(n)=excursion signal 13; and, third-order basis function signal 47″ is also responsive to X(n)·|X(n)|^{K}, but where K=2 and X(n)=excursion signal 13. The smaller dynamic range 136 of excursion signal 13, when compared to the full dynamic range of baseline communication signal 12, aids in the fixed-point implementation of RF transmitter 10. The second and third order relationship of basis function signals 47 to excursion signal 13 expands the resolution needed to appropriately describe basis function signals 47. But by starting with a reduced-range form of baseline communication signal 12, the resolution of basis function signals 47 is maintained at manageable levels. And, basis function signals 47 exhibit a zero magnitude in response to those portions of excursion signal 13 that exhibit a zero magnitude, i.e., the portions that corresponds to baseline communication signal 12 exhibiting a magnitude less than nonlinear threshold 100.

Referring back to FIGS. 1, 2, and 6, the modulation of convergence factors (“p”) 43′ and 43″ in response to the magnitude of baseline communication signal 12, or another signal derived therefrom, is shown. For the purposes of generating a modulated convergence factor 43′ or 43″ it is not critical that baseline communication signal 12 be directly monitored because many signals derived from baseline communication signal 12 are correlated to baseline communication signal 12 with respect to magnitude. Such other signals include excursion signal 13, linear-predistorted communication signal 28, nonlinear distortion cancellation signals 52 and/or 52′, feedback signal 20, and the like. Convergence factors 43′ and 43″ are respectively applied to the adaptive equalizers 30′ and 30″ that filter second-order and third-order basis function signals 47′ and 47″. Lower levels for convergence factors 43′ and 43″ indicate slower convergence operation of the feedback loops that control the adjustment of tap coefficients in the respective adaptive equalizers 30′ and 30″, and higher levels indicate faster convergence. Slower convergence operation causes the feedback loops to be less responsive to noise, and faster convergence causes the feedback loops to more quickly track changes. In one embodiment, the lower levels depicted in FIG. 6 represent a value of zero for the respective convergence factors 43′ and 43″, which causes all tap adjustments to cease and freezes the values of tap coefficients 34. In another embodiment, convergence factors 43′ and 43″ are proportional in amplitude to excursion signal 13, but delayed in time so as to be temporally aligned with error signal 54′.

As indicated by a dotted line connection of convergence factor 43 to leaky integrators 46 in FIG. 2, the offset which is subtracted from the integrator value in leaky integrators 46 during each clock cycle is desirably proportional or otherwise responsive to convergence factor 43. Thus, when convergence factor 43 exhibits zero, coefficients 34 are truly frozen. But when convergence factor 43 is not zero, coefficients 34 are allowed to leak toward zero when the LMS update algorithm does not override the leakage offset.

FIG. 6 depicts the operation of splitting section 94 (FIG. 1) for one embodiment of nonlinear predistorter 24. In this embodiment, splitting section 94 routes alternate pulses from primary convergence factor signal 41 to alternate adaptive equalizers 30′ and 30″ in a ping-pong fashion. Thus, the union of convergence factors 43′ and 43″ substantially equals primary convergence factor signal 41. The right-pointing arrows on the traces depicting convergence factors 43′ and 43″ in FIG. 6 indicate that the actual timing of these signals is delayed from what is depicted in FIG. 6 due to the operation of delay element 89 (FIG. 1) so that convergence factors 43′ and 43″ are temporally aligned with error signal 54′.

As discussed above, nonlinear threshold 100 is desirably set at a magnitude for communication signal 12 which corresponds to an amplitude where HPA 72 (FIG. 1) begins to generate significant amounts of nonlinear energy. When communication signal 12 is below nonlinear threshold 100, HPA 72 is not likely to produce a significant amount of nonlinear energy. By effectively freezing tap coefficient adjustment in adaptive equalizers 30′ and 30″ during such situations, nonlinear predistorter 24 is less likely to drift away from a more optimal setting obtained when the production of nonlinear energy was more likely, and nonlinear predistorter 24 is less likely to respond to noise detected during such periods. The splitting of primary convergence factor signal 41 into two mutually exclusive alternates 43′ and 43″ further decouples the two feedback loops that adjust tap coefficients in adaptive equalizers for basis function signals 47′ and 47″. But the splitting of primary convergence factor signal 41 is not a requirement of the present invention, and primary convergence factor signal 41 may be directly used as convergence factor 43 for both adaptive equalizers 30′ and 30″ in nonlinear predistorter 24 in an alternate embodiment.

While FIG. 6 shows that convergence factors 43′ and 43″ may change abruptly between faster and slower convergence levels, other modulation functions may also be applied. For example, rather than relying on a comparison with nonlinear threshold 100, convergence factors 43′ and 43″ may be modulated to be inversely proportional to the amplitude of baseline communication signal 12, or the variants thereof.

FIG. 8 graphically shows an example of how excursion magnitude signal 150′ (FIG. 7), as well as the magnitude of baseline communication signal 12 and the magnitude of other signals that are responsive to baseline communication signal 12 may vary over time.

Referring back to FIGS. 3 and 8, the slope of the relationship between input signal magnitude and output signal magnitude for HPA 72 while operating in nonlinear region 98 is constantly diminishing as input signal magnitude increases. Accordingly, at least the first derivative of this relationship changes as a function of input signal magnitude. Since derivatives of this relationship are not constant, a Taylor series expansion at one magnitude point that equates output characteristics of HPA 72 to a series of higher-ordered derivative components would not accurately equate at another magnitude point. Thus, in one embodiment of the present invention, the character of nonlinear predistortion energy defined by the operation of adaptive equalizers 30′ and 30″ is responsive to the magnitude of baseline communication signal 12.

FIG. 8 depicts the establishment of a number of magnitude zones, labeled zone 0, zone 1, zone 2, and zone 3. The precise number of zones to be established is not critical, but a greater number of zones better matches nonlinear predistortion energy to the differing character of nonlinear energy produced by HPA 72 while operating in nonlinear region 98. In accordance with the zonal definitions set forth in FIG. 8, zone 3 corresponds to the highest magnitude that the signal input to HPA 72 can exhibit and zone 0 the lowest. Desirably, zone 0 depicts operation in nonlinear region 98, but this is not a requirement. One or more zones may alternatively be established for operation in linear region 96 (FIG. 3), although desirably little effect will result because little nonlinear energy is produced while operating in linear region 96. In the embodiment depicted in FIG. 8, both of adaptive equalizers 30′ and 30″ included in nonlinear predistorter 24 use the same map of magnitude zones. But in an alternate embodiment, adaptive equalizer 30′ may use a different map of magnitude zones from adaptive equalizer 30″, with the boundaries between the magnitude zones for one adaptive equalizer falling somewhere in the center of the magnitude zones for the other.

As discussed below, in one embodiment of the present invention tap coefficients 34 (FIG. 2) vary depending upon the magnitude zone being filtered by adaptive equalizers 30′ and 30″. This allows different tap coefficients 34 to be defined for operation in different magnitude zones to better match nonlinear predistortion energy with the nonlinear energy produced in HPA 72 as it amplifies an input signal that exhibits a range in magnitude.

Referring back to FIG. 2, what is referred to herein as a “cell” 164 of an adaptive equalizer 30′ or 30″ is depicted as being enclosed within a dotted-line box. Cell 164 forms a single one of the tap coefficients 34 for FIR filter 32. One cell 164 is included in adaptive equalizer 30 for each tap coefficient 34. One input to a cell 164 is the correlation product 166 output by the multiplier 42 that corresponds to the tap coefficient 34. Another input is an appropriate convergence factor 43. In order for different tap coefficients 34 to be defined for operation in different magnitude zones, cells 164 may be configured as discussed below.

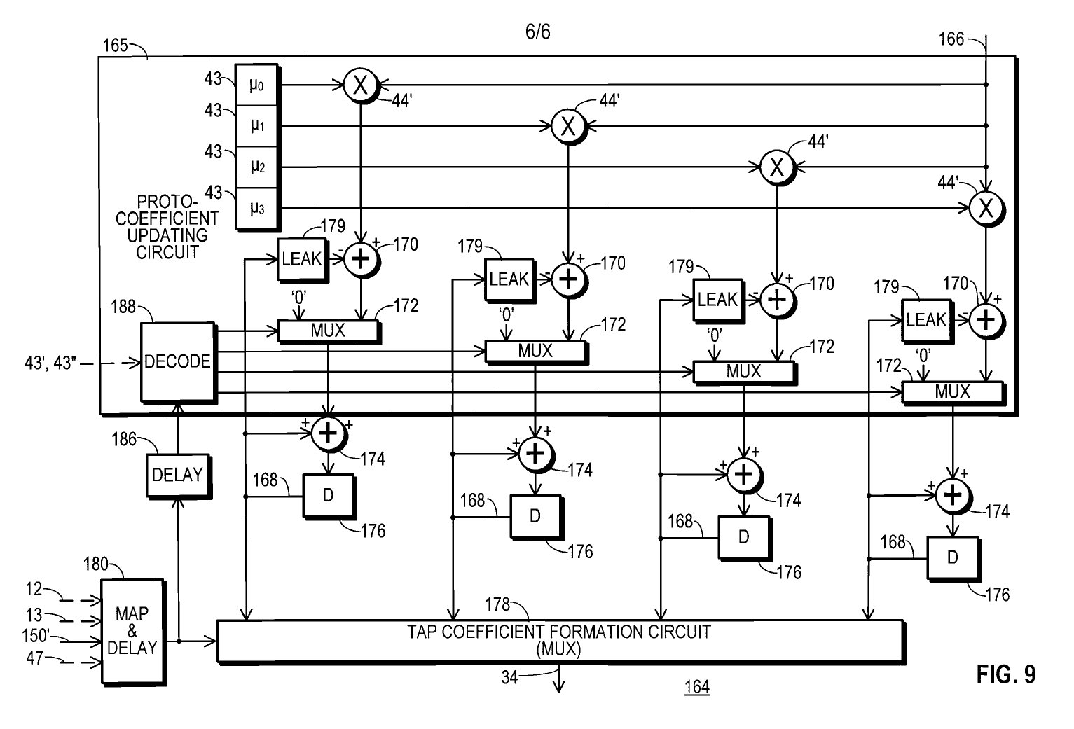

FIG. 9 shows a block diagram of a single cell 164 of adaptive equalizers 30′ and 30″ in one embodiment of the present invention. In this embodiment, all cells 164 of adaptive equalizers 30′ and 30″ are desirably configured as indicated in FIG. 9. In general, cell 164 maintains at least two proto-coefficients 168, and maintains one proto-coefficient for each magnitude zone in the embodiment depicted in FIG. 9. Proto-coefficients 168 are updated in accordance with an LMS algorithm and a leaky-tap algorithm, as discussed above in connection with FIG. 2. Using typical values for convergence factors 43, proto-coefficients 168 are relative static in that they change very little, if any, on a sample-by-sample basis. On the other hand, cell 164 forms a tap coefficient 34 from proto-coefficients 168 and a magnitude parameter on a sample-by-sample basis. Tap coefficient 34 is relatively dynamic compared to proto-coefficients 166 because it can change significantly from sample-to-sample since it is formed in response to magnitude changes of baseline communication signal 12.

In the embodiment depicted in FIG. 9, correlation product 166 for cell 164 is provided to a proto-coefficient updating circuit 165. In particular, within proto-coefficient updating circuit 165 correlation product 166 is provided to first inputs of multipliers 44′, with one multiplier 44′ being supplied for each proto-coefficient 168. Second inputs of multipliers 44′ are driven by appropriate convergence factors 43, labeled p0 through p3. One convergence factor 43 is provided for each magnitude zone depicted in FIG. 8. Thus, a greater convergence factor may be utilized for magnitude zone 3 (FIG. 3) which typically experiences far fewer samples in a given period of time than lower-magnitude zones, to improve convergence rates. Convergence factors 43 may be modulated as discussed above. Outputs of multipliers 44′ are routed to respective leaky integrators, and in particular to positive inputs of respective summation circuits 170 thereof.

In an alternate embodiment, a single convergence factor 43 may be used for all magnitude zones, with the result that proto-coefficients 168 for higher magnitude zones may converge more slowly than those for lower magnitude zones. In this embodiment, a single multiplier 44 may be driven by the single convergence factor 43 and its output routed to summation circuits 170 for each proto-coefficient 168.

For each proto-coefficient 168, an output of its summation circuit 170 is routed to a first input of a multiplexer (MUX) 172, and a second input of the multiplexer 172 is configured to receive a constant value of zero. For each proto-coefficient 168, an output of its multiplexer 172 exits proto-coefficient updating circuit 165 and couples to a first positive input of a summation circuit 174. For each proto-coefficient 168, an output of summation circuit 174 drives a memory element (D) 176 which maintains the proto-coefficient 168. For each proto-coefficient 168, an output of memory element 176 supplies the then-current value of proto-coefficient 168 to a second positive input of the corresponding summation circuit 174, to a respective data input of a tap coefficient formation circuit 178, and to an input of a leak value calculation circuit (LEAK) 179 for the proto-coefficient. Leak value calculation circuit 179 resides within proto-coefficient updating circuit 165. For each proto-coefficient 168, an output of the leak value calculation circuit 179 couples to a negative input of the corresponding summation circuit 170.

In one embodiment, tap coefficient formation circuit 178 may be provided by a multiplexer (MUX) which is controlled to select one of the proto-coefficients 168 presented to it while processing each sample. The control of the multiplexer may be provided in a manner that is responsive to baseline communication signal 12.

In a preferred embodiment, magnitude excursion signal 150′ is provided to a map and delay circuit 180. Map and delay circuit 180 maps magnitude excursion signal 150′ into a two-bit value that exhibits different states for magnitude zones 0-3. As discussed above, different mappings may be defined for adaptive equalizer 30′ than are used by adaptive equalizer 30″. Moreover, a single map and delay circuit 180 need not be duplicated in each cell 164 but may serve all cells 164 in a given adaptive equalizer 30′ or 30″. The output of map and delay circuit 180 is referred to as a magnitude zone index herein. Map and delay circuit 180 also inserts sufficient delay for the corresponding portion of baseline communication signal 12 to become temporally aligned with the filtering taking place in FIR filter 32 (FIG. 2).

FIG. 10 schematically shows relative timings of events which occur within RF transmitter 10 while processing information associated with a single sample of baseline communication signal 12. In FIG. 10, timing is depicted through a period of time that includes events 0-7. Higher numbered events occur after lower numbered events. While FIG. 10 shows events 0-7 as being equally spaced apart in time for convenience, such equal spacing is neither required nor desired.

The top trace in FIG. 10 depicts a sample 182 (FIG. 8) that occurs in baseline communication signal 12 at event 0. For the sake of discussion, the magnitude of sample 182 is assumed to be greater than nonlinear threshold 100 (FIG. 3), and in accordance with the depiction of FIG. 8 is classified in magnitude zone 2. As discussed above in connection with FIG. 4, excursion signal 13 is generated in response to baseline communication 12. But the generation of excursion signal 13 takes time, and sample 182 is not present in excursion signal 13 until event 1. Although not specifically depicted in FIG. 10, excursion magnitude signal 150′ (FIGS. 7 and 8) is generated in response to baseline communication 12 and excursion signal 13, but is generated slightly after event 1 due to the operation of magnitude circuit 150 (FIG. 7). FIG. 10 shows that sample 182 appears in basis function signals 47 at event 2. Basis function signals 47 are generated in response to baseline communication 12, excursion signal 13, and excursion magnitude signal 150′.

FIG. 10 depicts sample 182 as occurring in nonlinear distortion cancellation signal 52 (FIG. 1) at event 3. This occurs soon after filtering in FIR filters 32 within adaptive equalizers 30′ and 30″. As indicated by an interval bracket 184 in FIG. 10, since FIR filter 32 is a filter, it actually smears the influence of a single sample over a wide interval. For convenience, FIG. 10 depicts sample 182 as occurring in the center of interval bracket 184.

Referring to FIGS. 9-10, the amount of delay imposed by map and delay circuit 180 depends upon which signal responsive to baseline communication signal 12 is used in driving map and delay circuit 180. If baseline communication signal 12 is directly used to drive map and delay circuit 180, then a delay from event 0 to event 3 is imposed. Excursion signal 13 is responsive to baseline communication signal 12 and may alternatively be used to drive map and delay circuit 180. In this case, map and delay circuit 180 desirably imposes a delay from event 1 to event 3. Excursion magnitude signal 150′ is responsive to baseline communication signal 12 and may be used to drive map and delay circuit 180. In this case, map and delay circuit 180 desirably imposes a delay (not shown) slightly less than from event 1 to event 3. Basis function signals 47 are also responsive to baseline communication signal 12 and may be used to drive map and delay circuit 180. In this case, map and delay circuit 180 desirably imposes a delay from event 2 to event 3.

Regardless of which driving signal is used, map and delay circuit 180 imposes sufficient delay so that a sample occurring at event 0 in baseline communication signal 12 and corresponding to the filtering occurring in FIR filters 32 at event 3 is now temporally aligned with event 3. Thus, the portion of baseline communication signal 12 that corresponds to the filtering occurring at FIR filters 32 at each instant is used to form tap coefficient 34 from proto-coefficients 168. In the embodiment of cell 164 depicted in FIG. 9, this portion of baseline communication signal 12, and more particularly the magnitude of baseline communication signal 12 for the very sample being filtered in FIR filters 32, in a processed form as presented by through a basis function signal 47, forms tap coefficient 34 by selecting one of proto-coefficients 168 to serve as tap coefficient 34 for that sample.

The magnitude zone index output from map and delay circuit 180 which controls tap coefficient formation in tap coefficient formation circuit 178 is then delayed further in a delay circuit 186 and presented to a decoder 188 within proto-coefficient updating circuit 165. One output is provided from decoder 188 for each proto-coefficient 168. The outputs from decoder 188 respectively couple to selection inputs of multiplexers 172. Delay circuit 186 and decoder 188 need not be duplicated in each cell 164 but may be provided once for each instance of map and delay circuit 180.

The same magnitude zone index that was used in forming tap coefficient 34 from proto-coefficients 168 is used later to update proto-coefficients 168 in accordance with an LMS algorithm. At that later point in time, the magnitude zone index is used to identify which one of proto-coefficients 168 to update. That one proto-coefficient 168 is updated by routing the leakage-adjusted correlation product, as scaled by an appropriate convergence factor 43, through the selected multiplexer 172 to drive an integrator which consists of summation circuit 174 and memory element 176. In this embodiment, all other, non-selected, proto-coefficients 168 are prevented from changing. The corresponding multiplexers 172 route their zero input values to the integrators so that their proto-coefficients 168 do not change. Accordingly, the outputs from decoder 188 in this embodiment also act as convergence factors. They modulate the updating of proto-coefficients. In one embodiment, all convergence factor outputs from decoder 188 are disabled during operation in linear region 96 (FIG. 3) to prevent the updating of any proto-coefficient 168 during the linear operation of HPA 72. This embodiment is indicated by the dotted-line input from convergence signals 43′ and/or 43″ to decoder 188.

The duration of delay imposed by delay element 186 is explained by reference to FIGS. 1 and 10. Following sample 182 as it flows through RF receiver 10, event 4 occurs when sample 182 appears in predistorted communication signal 59. Sample 182 simultaneously arrives at event 4 through two paths, one of which extends through linear predistorter 22 and the other of which extends through nonlinear predistorter 24. Event 5 occurs when sample 182 appears in RF communication signal 16. Event 6 occurs when sample 182 arrives at combiner 88 for generating error signal 54. Sample 182 simultaneously arrives at combiner 88 through two paths, one of which is in feedback signal 20 by way of downconverter 82 and the other of which is in delayed baseline communication signal 12′ by way of time alignment block 26.

Accordingly, the generation of error signal 54 for corresponding samples of baseline communication signal 12 occurs after filtering in FIR filters 32. Sample 182 then arrives at event 7, again by simultaneously traversing two paths. One path is in conjugate error signal 54′ and the other is in delayed basis function signal 49. Referring to FIG. 2, at event 7 sample 182 is present in the delayed basis function signal 49 presented to tapped delay lines 38 of adaptive equalizers 30′ and 30″. Sample 182 is also present in conjugate error signal 54′ presented to delay element 40 of adaptive equalizers 30′ and 30″.

It is at event 7 that the same magnitude zone index that was previously used in forming tap coefficient 34 from proto-coefficients 168 is desirably used to appropriately update proto-coefficients 168 in accordance with the LMS algorithm. In particular, updating is performed in response to correlation, as determined by multipliers 42 (FIG. 2), between the conjugate form of error signal 54 and the delayed version of basis function signal 47. Delay element 186 inserts delay equivalent to the temporal difference between events 7 and 2.

Those skilled in the art will appreciate that FIG. 9 presents only one of a variety of different embodiments which may be used to form tap coefficient 34 from at least two proto-coefficients 168 in response to the magnitude of the portion of baseline communication signal 12 that corresponds to the signal being filtered in adaptive equalizers 30′ and 30″. In one alternative embodiment, all proto-coefficients 168 for magnitude zones lower than an indicated magnitude zone are summed together in tap coefficient formation circuit 178 to form tap coefficient 34.

In another alternative embodiment, different convergence factors 43 are used for different magnitude zones, as depicted in FIG. 9. In tap coefficient formation circuit 178, either a single one of several proto-coefficients 168 may be selected to form tap coefficient 34 or some or all of proto-coefficients 168 may be summed together to form tap coefficient 34. For updating proto-coefficients 168, convergence factors 43 may be modulated in response to magnitude information. Convergence factors 43 for magnitude zones further displaced from an actual magnitude of the corresponding portion of baseline communication signal 12 are modulated to low levels to restrict updating while convergence factors 43 for the magnitude zone in which the corresponding portion of baseline communication signal 12 is found is modulated to a high level to amplify the updating process.

In yet another alternative embodiment, instead of establishing a plurality of magnitude zones, one proto-coefficient 168 may represent a coefficient that accurately applies only at an average magnitude value for the entirety of nonlinear range 98 (FIG. 3) and another proto-coefficient 168 may represent a proto-coefficient slope. An assumption is made that tap coefficients 34 should change roughly linearly from a proper value suitable for a low magnitude signal to a proper values for a high magnitude signal. The proto-coefficient slope describes this rate of change as a function of magnitude. Tap coefficient formation circuit 178 may be configured to interpolate or extrapolate a tap coefficient 34 in response to the two proto-coefficients 168 and the difference in magnitude between the corresponding portion of baseline communication signal 12 and the average magnitude value at which the average tap coefficient value accurately applies. The slope proto-coefficient 168 may be determined by evaluating the difference between tap coefficients determined by serially restricting coefficient updating to only higher and only lower magnitude ranges. Or, the slope may be determined through the use of a control circuit that slowly but continuously perturbs the slope by small amounts in positive and negative directions and that integrates results to accumulate those small perturbations that yield better results.

In summary, the present invention provides an improved RF transmitter with nonlinear predistortion and a method therefor. In at least one embodiment of the present invention the configuration of nonlinear energy intentionally generated for purposes of cancellation in response to the operation of a feedback control loop is improved compared to prior versions that use a full-range baseline communication 12 to generate basis function signals. In at least one embodiment of the present invention, nonlinear energy intentionally generated for purposes of cancellation is blocked at times when a power amplifier is unlikely to be producing nonlinear energy. In at least one embodiment of the present invention, nonlinear energy intentionally generated for purposes of cancellation is generated from an excursion signal 13 that resembles a baseband communication signal 12 in some aspects but has a reduced dynamic range. In at least one embodiment of the present invention, an adaptive equalizer that establishes, at least in part, the configuration of nonlinear energy intentionally generated for purposes of cancellation is restricted in adapting its tap coefficients at times when a power amplifier is unlikely to be producing nonlinear energy. In at least one embodiment of the present invention, an adaptive equalizer that establishes, at least in part, the configuration of nonlinear energy intentionally generated for purposes of cancellation adjusts that configuration in response to the magnitude of a baseband communication signal. And, in at least one embodiment of the present invention, an adaptive equalizer that establishes, at least in part, the configuration of nonlinear energy intentionally generated for purposes of cancellation forms tap coefficients from proto-coefficients in response to signal magnitude at a time corresponding to the filtering taking place in the adaptive equalizer, then later adapts the proto-coefficients through an LMS process.

Although the preferred embodiments of the invention have been illustrated and described in detail, it will be readily apparent to those skilled in the art that various modifications may be made therein without departing from the spirit of the invention or from the scope of the appended claims. For example, no requirement exists that orthogonal basis function signals be used in basis function generation section 48. These and other modifications and adaptations which are obvious to those skilled in the art are to be included within the scope of the present invention.

What is claimed is:

1. A method of operating a radio-frequency (RF) transmitter having an RF amplifier, said method comprising:
generating a basis function signal in response to a baseline communication signal;
filtering said basis function signal to form a nonlinear distortion cancellation signal;
configuring said nonlinear distortion cancellation signal to exhibit approximately zero magnitude in correspondence to said baseline communication signal exhibiting a magnitude less than a nonlinear threshold, said nonlinear threshold being a magnitude of said baseline communication signal at which said RF amplifier begins to produce a substantial amount of nonlinear distortion;
combining said nonlinear distortion cancellation signal with said baseline communication signal to produce a predistorted communication signal; and
processing said predistorted communication signal through analog transmitter components.

2. A method as claimed in claim 1 wherein:
said filtering activity filters said basis function signal in an adaptive equalizer having an adaptable tap coefficient;
said processing activity produces an RF communication signal;
said method additionally comprises forming a feedback signal from said RF communication signal; and
said method additionally comprises adjusting said tap coefficient in response to said feedback signal.

3. A method as claimed in claim 2 wherein:
said filtering activity comprises forming said tap coefficient from at least two proto-coefficients in response to a portion of said baseline communication signal which corresponds to said filtering activity; and
said adjusting activity comprises:
generating an error signal subsequent to said filtering activity, said error signal being generated from said feedback signal and a delayed version of said baseline communication signal, said delayed version of said baseline communication signal being delayed relative to said filtering activity; and
updating at least one of said proto-coefficients in response to correlation between said error signal and a delayed version of said basis function signal.

4. A method as claimed in claim 2 wherein:
said filtering activity comprises forming said tap coefficient from at least two proto-coefficients; and
said adjusting activity comprises updating at least one of said proto-coefficients subsequent to said filtering activity.

5. A method as claimed in claim 2 wherein:
said adjusting activity adjusts said at least one tap coefficient in response to said feedback signal and in response to a convergence factor; and
said method additionally comprises modulating said convergence factor in response to a magnitude exhibited by at least one of said baseline communication signal, said predistorted communication signal and said feedback signal.

6. A method as claimed in claim 2 wherein said forming activity comprises downconverting said RF communication signal using a digital-subharmonic-sampling downconverter.

7. A method as claimed in claim 2 wherein:
said adaptive equalizer is a first adaptive equalizer;
said predistorted communication signal is a linear-and-nonlinear predistorted communication signal;
said method additionally comprises filtering said baseline communication signal in a second adaptive equalizer having at least one adaptable tap coefficient to form a linear predistorted communication signal;
said combining activity combines said nonlinear distortion cancellation signal with said linear predistorted communication signal to produce said linear-and-nonlinear predistorted communication signal; and
said method additionally comprises adjusting said at least one tap coefficient of said second adaptive equalizer in response to said feedback signal.

8. A method as claimed in claim 1 wherein:
said method additionally comprises forming an excursion signal, X(n), from said baseline communication signal; and
said generating activity is configured so that said basis function signal is responsive to X(n)·|X(n)|^{K}, where K is an integer greater than or equal to one.

9. A method as claimed in claim 8 wherein said excursion signal exhibits substantially the same phase as said baseline communication signal but a reduced magnitude from said baseline communication signal.

10. A method as claimed in claim 9 wherein at least a portion of said excursion signal exhibits a magnitude which is reduced from the magnitude of said baseline communication signal by an offset substantially equal to said nonlinear threshold.

11. A method as claimed in claim 8 wherein said basis function signal is a first basis function signal, said nonlinear distortion cancellation signal is a first nonlinear distortion cancellation signal, and said method additionally comprises:
generating a second basis function signal, said second basis function signal being responsive to X(n)·|X(n)|^{K+1};
filtering said second basis function signal to produce a second nonlinear distortion cancellation signal; and
combining said first and second nonlinear distortion cancellation signals.

12. A method as claimed in claim 1 wherein:
said baseline communication signal is a full-range baseline communication signal;
said method additionally comprises forming a reduced-range baseline communication signal in response to said full-range baseline communication signal, said reduced-range baseline communication signal exhibiting a smaller dynamic range than said full-range baseline communication signal; and
said generating activity generates said basis function signal in response to said reduced-range baseline communication signal.

13. A method of operating a radio-frequency (RF) transmitter, said method comprising:
forming a reduced-range baseline communication signal in response to a full-range baseline communication signal, said reduced-range baseline communication signal exhibiting a smaller dynamic range than said full-range baseline communication signal;
generating a basis function signal responsive to said reduced-range baseline communication signal;
filtering said basis function signal to form a nonlinear distortion cancellation signal;
combining said nonlinear distortion cancellation signal with said baseline communication signal to produce a predistorted communication signal; and
processing said predistorted communication signal through analog transmitter components.

14. A method as claimed in claim 13 wherein:
said filtering activity filters said basis function signal in an adaptive equalizer having an adaptable tap coefficient;
said processing activity produces an RF communication signal;
said method additionally comprises forming a feedback signal from said RF communication signal; and
said method additionally comprises adjusting said tap coefficient in response to said feedback signal.

15. A method as claimed in claim 14 wherein:
said filtering activity comprises forming said tap coefficient from at least two proto-coefficients in response to a portion of said baseline communication signal which corresponds to said filtering activity; and
said adjusting activity comprises:
generating an error signal subsequent to said filtering activity, said error signal being generated from said feedback signal and a delayed version of said baseline communication signal, said delayed version of said baseline communication signal being delayed relative to said filtering activity; and
updating at least one of said proto-coefficients in response to correlation between said error signal and a delayed version of said basis function signal.

16. A method as claimed in claim 14 wherein:
said filtering activity comprises forming said tap coefficient from at least two proto-coefficients; and
said adjusting activity comprises updating at least one of said proto-coefficients subsequent to said filtering activity.

17. A method as claimed in claim 14 wherein:
said adjusting activity adjusts said at least one tap coefficient in response to said feedback signal and in response to a convergence factor; and
said method additionally comprises modulating said convergence factor in response to a magnitude exhibited by at least one of said baseline communication signal, said predistorted communication signal and said feedback signal.

18. A method as claimed in claim 14 wherein said forming activity comprises downconverting said RF communication signal using a digital-subharmonic-sampling downconverter.

19. A method as claimed in claim 14 wherein:
said adaptive equalizer is a first adaptive equalizer;
said predistorted communication signal is a linear-and-nonlinear predistorted communication signal;
said method additionally comprises filtering said baseline communication signal in a second adaptive equalizer having at least one adaptable tap coefficient to form a linear predistorted communication signal;
said combining activity combines said nonlinear distortion cancellation signal with said linear predistorted communication signal to produce said linear-and-nonlinear predistorted communication signal; and
said method additionally comprises adjusting said at least one tap coefficient of said second adaptive equalizer in response to said feedback signal.

20. A method as claimed in claim 13 wherein said generating activity is configured so that said basis function signal is responsive to X(n)·|X(n)|^{K}, where K is an integer greater than or equal to one, and X(n) represents said reduced-range baseline communication signal.

21. A method as claimed in claim 20 wherein said basis function signal is a first basis function signal, said nonlinear distortion cancellation signal is a first nonlinear distortion cancellation signal, and said method additionally comprises:
generating a second basis function signal, said second basis function signal being responsive to X(n)·|X(n)|^{K+1};
filtering said second basis function signal to produce a second nonlinear distortion cancellation signal; and
combining said first and second nonlinear distortion cancellation signals.

22. A method as claimed in claim 13 additionally comprising configuring said nonlinear distortion cancellation signal to exhibit approximately zero magnitude for all values of said baseline communication signal less than a nonlinear threshold, said nonlinear threshold being a magnitude of said baseline communication signal at which an RF amplifier of said RF transmitter begins to produce a substantial amount of nonlinear distortion.

23. A method as claimed in claim 22 wherein said configuring activity is implemented by setting said reduced-range baseline communication signal to approximately zero magnitude in correspondence to said baseline communication signal being less than said nonlinear threshold.

24. A radio-frequency (RF) transmitter with nonlinear predistortion, said RF transmitter comprising:
a nonlinear predistorter having:
an excursion signal generator configured to form a reduced-range baseline communication signal in response to a full-range baseline communication signal, said reduced-range baseline communication signal exhibiting a smaller dynamic range than said full-range baseline communication signal;
a basis function generator responsive to said reduced-range baseline communication signal and configured to generate a basis function signal;
an adaptive equalizer responsive to said basis function signal and configured to form a nonlinear distortion cancellation signal;
a combiner responsive to said nonlinear distortion cancellation signal and said baseline communication signal and configured to produce a predistorted communication signal; and
a power amplifier located downstream of said combiner and configured to generate an RF communication signal.

25. A method as claimed in claim 24 wherein said adaptive equalizer filters said basis function signal in response to a tap coefficient to form said nonlinear distortion cancellation signal, and said adaptive equalizer comprises:
a tap coefficient formation circuit configured to form said tap coefficient from at least two proto-coefficients; and
a proto-coefficient updating circuit configured to update at least one of said proto-coefficients subsequent to use of said at least one of said proto-coefficients to filter said basis function signal.

26. A method as claimed in claim 24 wherein said tap coefficient formation circuit is responsive to a magnitude of a portion of said full-range baseline communication signal which corresponds to said filtering of said basis function signal in said adaptive equalizer.

27. An RF transmitter as claimed in claim 24 additionally comprising:
a downconverter having an input adapted to receive said RF communication signal, said downconverter being configured to produce a feedback signal; and
an error signal generator having an input adapted to receive said feedback signal, said error signal generator being configured to produce an error signal which is supplied to said adaptive equalizer and is configured to be used by said adaptive equalizer in adjusting at least one tap coefficient of said adaptive equalizer.

28. An RF transmitter as claimed in claim 27 wherein:
said adaptive equalizer adjusts said at least one tap coefficient in response to said error signal and in response to a convergence factor; and
said RF transmitter additionally comprises a control section configured to modulate said convergence factor in response to a magnitude exhibited by at least one of said full-range baseline communication signal, said reduced-range baseline communication signal, said predistorted communication signal and said feedback signal.

29. An RF transmitter as claimed in claim 24 wherein said basis function generator is configured so that said basis function signal is responsive to X(n)·|X(n)|^{K}, where K is an integer greater than or equal to one and X(n) represents said reduced-range baseline communication signal.

30. An RF transmitter as claimed in claim 24 wherein said nonlinear distortion cancellation signal is configured to exhibit approximately zero magnitude in correspondence to said baseline communication signal being less than a nonlinear threshold, said nonlinear threshold being a magnitude of said baseline communication signal at which an RF amplifier of said RF transmitter begins to produce a substantial amount of nonlinear distortion.

31. An RF transmitter as claimed in claim 30 wherein said excursion signal generator is configured so that said reduced-range baseline communication signal exhibits an approximately zero magnitude when said baseline communication signal is less than said nonlinear threshold.

32. A method of operating a radio-frequency (RF) transmitter, said method comprising:
generating a basis function signal responsive to a baseline communication signal;
filtering said basis function signal in an adaptive equalizer having an adaptable tap coefficient to form a nonlinear distortion cancellation signal;
combining said nonlinear distortion cancellation signal with said baseline communication signal to produce a predistorted communication signal;
processing said predistorted communication signal through analog transmitter components to generate an RF communication signal;
generating a feedback signal in response to said RF communication signal;
adjusting said tap coefficient in response to said feedback signal and in response to a convergence factor; and
modulating said convergence factor in response to a magnitude exhibited by at least one of said baseline communication signal, said predistorted communication signal and said feedback signal.

33. A method as claimed in claim 32 wherein said modulating activity is configured to cause faster convergence at a higher magnitude and to cause slower convergence at a lower magnitude.

34. A method as claimed in claim 33 wherein said slower convergence causes said adjusting activity to cease adjustments to said at least one tap coefficient.

35. A method as claimed in claim 32 wherein:
said baseline communication signal is a full-range baseline communication signal;
said method additionally comprises forming a reduced-range baseline communication signal in response to said full-range baseline communication signal, said reduced-range baseline communication signal exhibiting a smaller dynamic range than said full-range baseline communication signal; and
said basis-function-generating activity is responsive to said reduced-range baseline communication signal.

36. A method as claimed in claim 32 additionally comprising configuring said nonlinear distortion cancellation signal to exhibit approximately zero magnitude in correspondence to said baseline communication signal exhibiting a magnitude less than a nonlinear threshold, said nonlinear threshold being a magnitude of said baseline communication signal at which an RF amplifier of said RF transmitter begins to produce a substantial amount of nonlinear distortion.

37. A method as claimed in claim 36 wherein said modulating activity is configured to cause slower convergence in correspondence to said baseline communication signal exhibiting said magnitude less than said nonlinear threshold.

38. A method as claimed in claim 37 wherein said modulating activity is configured to stop adjusting said at least one tap coefficient in correspondence to said baseline communication signal exhibiting said magnitude less than said nonlinear threshold.

39. A method as claimed in claim 32 wherein:
said filtering activity comprises forming said tap coefficient from at least two proto-coefficients in response to a portion of said baseline communication signal which corresponds to said filtering activity; and
said adjusting activity comprises:
generating an error signal subsequent to said filtering activity, said error signal being generated from said feedback signal and a delayed version of said baseline communication signal, said delayed version of said baseline communication signal being delayed relative to said filtering activity; and
updating at least one of said proto-coefficients in response to correlation between said error signal and a delayed version of said basis function signal.

40. A method as claimed in claim 32 wherein:
said filtering activity comprises forming said tap coefficient from at least two proto-coefficients; and
said adjusting activity comprises updating at least one of said proto-coefficients subsequent to said filtering activity.

41. A method of operating a radio-frequency (RF) transmitter, said method comprising:
generating a basis function signal responsive to a baseline communication signal;
filtering said basis function signal in an adaptive equalizer having a tap coefficient to form a nonlinear distortion cancellation signal, said tap coefficient being formed from at least two proto-coefficients in response to a portion of said baseline communication signal which corresponds to said filtering activity;
combining said nonlinear distortion cancellation signal with said baseline communication signal to produce a predistorted communication signal;
processing said predistorted communication signal through analog transmitter components to generate an RF communication signal;
generating a feedback signal in response to said RF communication signal; and
adjusting at least one of said proto-coefficients in response to said feedback signal.

42. A method as claimed in claim 41 wherein said tap coefficient is formed from said at least two proto-coefficients in response to a magnitude of said portion of said baseline communication signal which corresponds to said filtering activity.

43. A method as claimed in claim 41 wherein said adjusting activity comprises:
generating an error signal from said feedback signal and a delayed version of said baseline communication signal, said delayed version of said baseline communication signal being delayed relative to said filtering activity; and
updating at least one of said proto-coefficients in response to correlation between said error signal and a delayed version of said basis function signal.

44. A method as claimed in claim 41 wherein said tap coefficient is formed by selecting one or more of at least three proto-coefficients in response to said portion of said baseline communication signal which corresponds to said filtering activity.

45. A method as claimed in claim 41 wherein said tap coefficient is formed from said at least two proto-coefficients in response to a portion of said basis function signal which corresponds to said filtering activity.

46. A method as claimed in claim 41 wherein:
said baseline communication signal is provided in a full-range form;
said method additionally comprises forming a reduced-range baseline communication signal in response to said full-range form of said baseline communication signal, said reduced-range baseline communication signal exhibiting a smaller dynamic range than said full-range baseline communication signal;
said generating activity generates said basis function signal in response to said reduced-range baseline communication signal; and
said tap coefficient is formed from said at least two proto-coefficients in response to a portion of reduced-range baseline communication signal which corresponds to said filtering activity.

47. A method as claimed in claim 41 wherein:
said tap coefficient is relatively dynamic and changes in response to magnitude changes of said baseline communication signal; and
said at least two proto-coefficients are relatively static compared to said tap coefficient.
